(19) United States
(12) Patent Application Publication
(10) Pub. No.: US 2001/0037185 A1
(43) Pub. Date: Nov. 1, 2001

(54) Method for determining the state variables of a moving rigid body in space

(76) Inventors: Roland Strietzel, Dresden (DE); Karl-Hermann Kolk, Grosspuerschuetz (DE)

Correspondence Address: Gerald H. Kiel, Esq., REED SMITH LLP, 375 Park Avenue, New York, NY, 10152-1799, US

(21) Appl. No.: 09/798,556

(22) Filed: Mar. 2, 2001

(30) Foreign Application Priority Data
Mar. 3, 2000 (DE) 100 11 890.9

(51) Int. Cl. G06F 19/00; G01C 3/06; G01B 11/14

(52) U.S. Cl. 702/152; 356/141.1; 356/5.01

(57) ABSTRACT

A method for determining the state variables of a moving rigid body in space, in particular for determining the position and attitude of a spacecraft during an approach and docking maneuver. The task of finding a new possibility for determining the state variables of a moving rigid body, which delivers a simplification and ensures a higher level of reliability in calculating the state variables is accomplished according to the invention in the case of a method for determining the state variables of a moving rigid body by determining the state variables of the moving body with the aid of a state observer, in which case measured data of scannings of a plurality of retroreflectors in space are processed by an internal memory model to produce the desired output signal of the state variables of the moving body, starting from set initial values and known system parameters implemented in operators, a current state vector of the moving body being calculated as an estimate, and being adapted to the actual attitude characteristic and movement characteristic of the body with each measuring cycle by a correction, such that after a specific number of measuring and calculating cycles the estimated values track the actual movement data of the body in space and are used as state variables of the body.

### BACKGROUND OF THE INVENTION

a) Field of the Invention

The invention relates to a method for determining the state variables of a moving rigid body in space, in particular for determining the position and attitude of a spacecraft during an approach and docking maneuver.

b) Description of the Related Art

In space flight and in robotics, it is frequently necessary to determine the position and attitude of two bodies relative to one another. This is of particular importance in space flight during coupling of spacecraft. Thus, at least six variables are required to control the docking operation:

a) the distance (in three coordinates x, y, z) and

b) the three Euler angles (roll angle, pitch angle, yaw angle—as in the case of an aircraft),

which must be determined in the simplest possible way.

Radar engineering supplies the simplest method of determining the distance and the direction of view from one body to another. In this case, laser radar sets have increasingly become established recently for the very short range, from a few hundred meters down to a few decimeters. The short wavelength of the light permits high accuracies in the variables of range, azimuth and elevation which are to be measured (in spherical coordinates) or in the components in Cartesian coordinates.

The radar set emits a transmitted beam which scans the field in which the target object (also: target, for example space station, spacecraft) is expected, and is reflected by the target object. The reflection, and thus the reliability of the measurement can be substantially improved when use is made of so-called retroreflectors which retroreflect the incident beam exactly in the opposite direction.

The measuring beam leaves the transmitter optics and is guided in linewise fashion over the observation field by a coordinated movement of azimuth and elevation mirrors. When the measuring beam strikes a rectroreflector, it is retroreflected in the opposite direction and therefore reaches the receiver optics of the radar set. At this moment, the measured data are determined by determining the mirror positions, and the range is calculated from the travel time of the beam from the transmitter to the receiver.

If it is desired to determine not only the position of the target, but also its attitude, it is necessary to use at least three retroreflectors which are arranged in a defined fashion in the coordinate system of the target. The position and the attitude of the target can be determined uniquely with reference to the coordinate system of the measuring device with the aid of such an arrangement composed of an active range finder (for example radar set, rendezvous sensor) and three retroreflectors such as has been proposed, for example, by Möbius, B. et al. (in: Development and Application of a Rendezvous and Docking Sensor “RVS”, International Conference on Space Optics, Toulouse, 1997). For this purpose, bearings are taken on the rectroreflectors simultaneously or sequentially in time, in order in each case to measure the range, azimuth and elevation. This means that it is possible in this way to determine the position (for example expressed by Cartesian coordinates x, y, z) and attitude (for example by specifying Euler angles) of the two coordinate systems relative to one another. If the active sensor—frequently also called rendezvous sensor (RVS)—and the retroreflector arrangement (as system components of the measurement process) are fixed, and thus do not move, it is possible to use geometrical relationships to determine from the nine measured values the total of six parameters for position and attitude of the two coordinate systems relative to one another.

In the case of the movement of at least one of the two system components (for example during approach and docking of two spacecraft), a problem arises with evaluating the measured values by virtue of the fact that during the measurements at the three retroreflectors of the body scanned by the RVS, both the relative position and the attitude are changing and the measurement results can no longer be assigned with complete ease. Thus, in order to determine position and attitude use has been made to date of approximate solutions on the basis of triangular relationships which take account of estimated values of the speeds.

A further disadvantage of this solution is the extensive use of trigonometric functions, which can only be implemented in onboard computers expensively and can cause ambiguities.

### OBJECT AND SUMMARY OF THE INVENTION

It is the primary object of the invention to find a new possibility for determining the state variables of a moving rigid body which is accompanied by simplification and ensures a higher level of reliability of the calculation of the state variables of the moving body. A widened object of the invention is to ensure the above-named aims even in the case of serial acquisition of measured values without increasing the outlay on evaluation.

According to the invention, the object is achieved in the case of a method for determining the state variables of a moving rigid body, such as relative position and attitude as well as translational and rotational speeds, in particular for a movement of approach to another body employing measured data provided by an active sensor, the measured data being derived from at least three rectroreflectors whose configuration on the other body is known and is assigned in a defined fashion to a body-specific coordinate system of the other body, by virtue of the fact that the state variables of the moving body are determined with the aid of a state observer which processes the measured data of scannings of the individual rectroreflectors in space by means of an internal memory model to produce the desired output of the state variables of the moving body, in which case, starting from set initial values and known system parameters implemented in operators, a current state vector of the moving body is calculated as an estimate, and a correction determined by linkage with the measured data is used to adapt this estimate with each measuring cycle to the actual attitude characteristic and movement characteristic of the moving body, such that after a specific number of measuring and calculating cycles the estimated values calculated in the state observer track the current movement data of the moving body in space to a very good approximation, and the calculated estimated values are used as state variables of the moving body.

The measured data are advantageously compared with the estimated values present in the state observer, a difference being determined from a measurement vector y(k) and a current estimate y*(k) of the measurement vector on the basis of an estimated state vector x*(k), k being a counting index of the running measurement clock and calculation clock, and being used to correct the estimated values. It proves to be expedient that an estimated measurement vector y*(k) for providing an estimated reference variable is generated from the currently estimated state vector x*(k) by means of an output matrix which contains the effect of the real state vector x(k) on the measurement vector y(k), a subsequent state of the state vector x*(k) is calculated from the currently estimated state vector x*(k) via a system matrix which takes account of influences of the system upon transition from a current state to a following state, and this subsequent state is corrected by means of the difference by using a return matrix which contains a rule for converting the difference into a correction of the current state, and after this correction a subsequent state vector x*(k+1) is yielded which is taken over into the current state vector x*(k) for the next clock. It is particularly advantageous in this case when the state observer is designed as a filter, in which case the output matrix and the return matrix are linked with the system matrix to generate an operator for generating a subsequent state which describes the relationship between the measurement vectors and two sequential estimated state vectors x*(k) and x*(k+1) without knowledge of an estimated measurement vector, the subsequent state of the current estimated state vector x*(k) is calculated therefrom by means of said operator, the generated subsequent state of the state vector is corrected with the aid of the measurement vector converted via the return matrix, and is transferred into the subsequent state vector x*(k+1), and the subsequent state vector x*(k+1) is provided optionally parallel to the still present current state vector x*(k) as output of the state observer.

A particularly simple variant of the invention consists in processing the measured data of a plurality of simultaneously scanned retroreflectors in the form of measurement vectors in the state observer simultaneously with the measurement clock frequency of the retroreflector scannings, a cycle clock of the calculations in the state observer corresponding to the measurement clock of the scanning of the retroreflectors.

Another configuration of the method according to the invention, which is advantageous because of savings in weight and volume, proceeds from the fact that the measured data are processed in the form of measurement vectors of a plurality of sequentially scanned retroreflectors in the state observer with a cycle clock frequency whose period corresponds to the duration of a series of scannings of all the retroreflectors with a measurement clock frequency, the measurement clock frequency being an integral multiple of the cycle clock frequency as a function of the number of retroreflectors used. In the case of this variant, the measurement vectors of the sequentially scanned retroreflectors are advantageously buffered in the state observer, weighted as a function of their temporal sequence and simultaneously processed in a cycle clock after termination of a series of scannings of all retroreflectors.

For this purpose, the measurement vectors yᵢ arriving sequentially in time are advantageously buffered in a state observer designed as a filter, and are weighted differently as a function of the measuring instant by means in each case of an associated return matrix and a weighting matrix which takes account of a forgetting rate dependent in terms of time on the age of the individual measurement vectors y₁, and the specifically weighted and subsequently combined measurement vectors yᵢ are used to correct the current state vector x*(k), which was previously multiplied by a matrix which embodies the memory over n measurement clocks.

In a particularly preferred variant of the invention, the measured data are processed in quasi-real time, with short-term buffering, in the form of measurement vectors of sequentially scanned retroreflectors in the state observer with a scanning frequency which corresponds to the mean duration of the scannings of each of the retroreflectors. In this case, the measurement vectors, which are in each case picked up in a defined sequence of the scanned retroreflectors, are processed without delay, in each case an individual measurement vector yᵢ(k) advantageously being weighted in the state observer with the aid of a return matrix which is appropriately matched to an output matrix specific to each retroreflector, and a subsequent state, which is instantly the initial state for processing the next measurement vector yᵢ₊₁(k+iΔ) of the subsequently scanned retroreflector, being calculated in each case from the weighted measurement vector yᵢ(k) and the present current state vector x*(k), which is multiplied by a matrix representing the memory via a measurement clock. In this advantageous variant, the estimated state vector x* is available after each measurement clock.

The fundamental idea of the method according to the invention is based on the presupposed provision of measured values from a space-scanning range-finding device (for example laser radar) of the moving body, and on the knowledge of a configuration of measurement points (retroreflectors) on the other body (target).

The essence is the determination of the continuously changing position and attitude between an active sensor and target with the aid of the currently scanned target measurement points, this being done by simulating the movement of the measuring device and target by means of processing the current measured values. In this process, sequential measurements are combined during the approach in a so-called state observer such that, starting from suitably selected initial values, the following state variables are calculated as estimated values immediately after each individual measurement of the retroreflectors:

the relative position in Cartesian coordinates, that is to say a position vector p between the coordinate systems of the active sensor and the target (3 variables),

the velocity components in the three coordinate directions (3 variables),

the quaternions relating to the attitude description (3 independent q₁, q₂, q₃, and one dependent variable q₄) which, instead of Euler angles, describe the attitude of a body with reference to a fixed inertial system, and

the angular speeds about the coordinate axes (3 variables).

In this method, consequently, 12 state variables of the moving body are estimated and are continuously corrected and updated by means of a comparison with the measured data of the scanning of the retroreflectors.

It is possible by using the method according to the invention to determine the state variables of a moving rigid body, this type of determination representing a simplification and a higher level of reliability of the calculation of the state variables of the moving body. Moreover, the method according to the invention succeeds without increasing the outlay on evaluation even in the case of serial measured value acquisition.

The invention is to be explained in more detail below with the aid of exemplary embodiments.

### BRIEF DESCRIPTION OF THE DRAWINGS

In the drawings:

FIG. 1 shows the relationship between the measurement vector r₁, target vector t₁ and position vector p;

FIG. 2 shows a measuring principle according to the invention consisting of a controlled system 1 and state observer 2;

FIG. 3 shows a view of the state observer 2 as a filter;

FIG. 4 shows a state observer 2 for sequential measurements at three retroreflectors Ri of a target, and simultaneous evaluation at the end of a cycle of measurements of all the retroreflectors Ri;

FIG. 5 shows a state observer 2 composed of three partial observers for the successive processing of measurement results within a measuring cycle;

FIG. 6 shows the transient response of the state observer; and

FIG. 7 shows the subsequent response of the state observer, illustrated with reference to the example of two quaternions.

### DESCRIPTION OF THE PREFERRED EMBODIMENTS

In order to explain the method according to the invention, the following boundary conditions are to be adopted as given, so as to facilitate the description.

It is immaterial for the functioning of the method according to the invention whether it is the body with the active sensor which moves or the other body (termed target subsequently) with the retroreflectors. It is assumed here expediently that an active rendezvous sensor is mounted on a moving spacecraft and that the target (for example a space station or another spacecraft) “is stationary”, that is to say a movement of the target is of no significance for the relative approach of the spacecraft. It is possible in this way for the determined state variables of the spacecraft to be used as results of the method according to the invention for directly controlling the moving spacecraft. Without limiting generality, the active rendezvous sensor is denoted below in a simplified fashion as a laser radar, since it is preferred to use such a device. Moreover, in order to simplify the explanations the number of retroreflectors is taken as three, since these suffice as a rule to define a surface in space (for example the docking surface of the other body) exactly in position (range) and attitude, when the distribution of the retroreflectors is suitably chosen and their configuration is known.

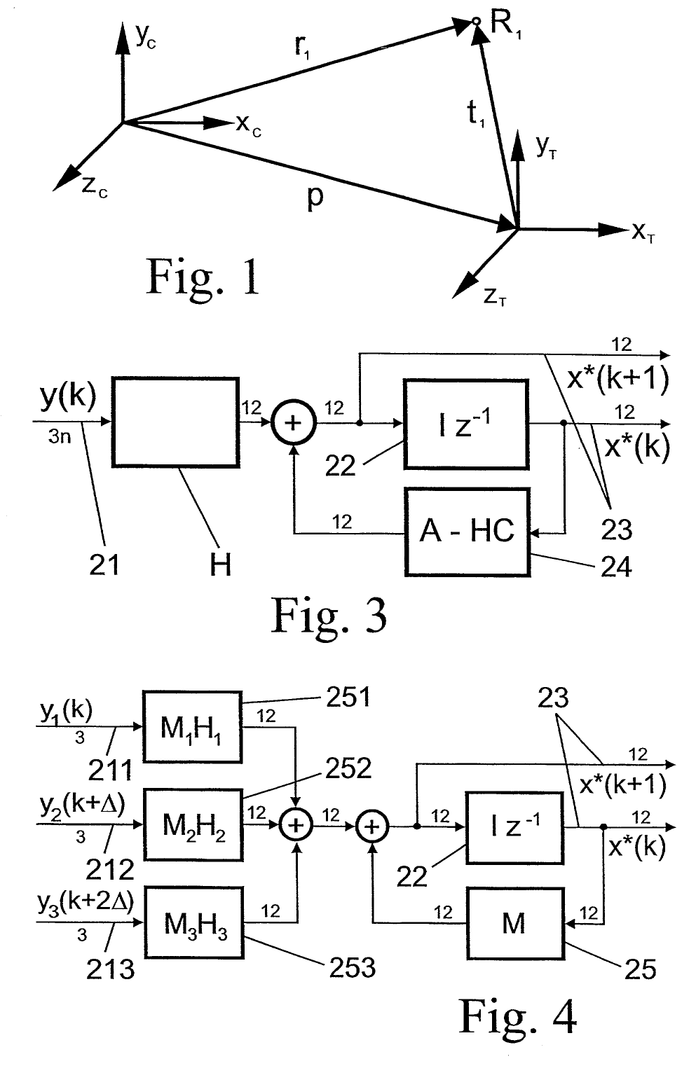

FIG. 1 illustrates the relationship between the measured data, state variables and the different coordinate systems of the moving body and the target which is to be approached (and possibly docked at). Here, a measurement vector r₁ constitutes the actual measured variable of the range to a first retroreflector R₁. The measurement vector r₁ specifies in the coordinate system (x_{C}, y_{C}, z_{C}) of the laser radar where the retroreflector R₁ is located. Also specified in the coordinate system (x_{C}, y_{C}, z_{C}) of the laser radar is a position vector p which points to the origin of a coordinate system (x_{T}, y_{T}, z_{T}) of the target. In the coordinate system (x_{T}, y_{T}, z_{T}) of the target, target vectors tᵢ are specified which point from the origin of coordinates thereof to the retroreflectors Rᵢ. For the purpose of simplification, only the target vector t₁ relating to the retroreflector R₁ is illustrated in FIG. 1. The arrangement of the retroreflectors Rᵢ in the coordinate system (x_{T}, y_{T}, z_{T}) is fixed with a corresponding assignment of further target vectors tᵢ.

If the two above-named coordinate systems can be transferred into one another by simple translation, the simple relationship

r₁=p+t₁ (1)

holds for the measurement vector r₁ pointing to the retroreflector R₁ in the vector representation in accordance with FIG. 1.

If the two coordinate systems are rotated with respect to one another, an attitude matrix Q must be included. It indicates how the target vector t₁, which is specified in the coordinate system (x_{T}, y_{T}, z_{T}) of the target, appears in the coordinate system (x_{C}, y_{C}, z_{C}) of the laser radar. The result of this is

r₁=p+Qt₁ (2)

Equation (2) shows how the state variables of the position with p(x, y, z) and attitude with Q (q₁, q₂, q₃, q₄) feature in the measurement result. Here, q₁, q₂, q₃, q₄ are quaternions which, instead of the Euler angles, can describe the attitude of a body with reference to a fixed coordinate system. In addition to the Euler angles, quaternions constitute an equivalent possibility for representing the attitude of a body with a coordinate system fixed in the body with reference to another coordinate system. They have the advantage that they can be used to represent the attitude matrix Q in equation (2) without trigonometric functions. The influence of the associated speeds is given by the temporal dependence, and is detected by repeated measurement of the retroreflectors Rᵢ.

It follows from equation (2) that of the twelve state variables to be determined only six state variables (x, y, z, q₁, q₂, q₃) determine the 3 components of the individual measurement vector r₁. Consequently, a specific number of measurements must be carried out simultaneously and sequentially in time at different and identical retroreflectors Rᵢ in order to compensate the information deficit of only one measurement.

Further equations analogous to equation (2) can be set up mutatis mutandis for the other retroreflectors Rᵢ.

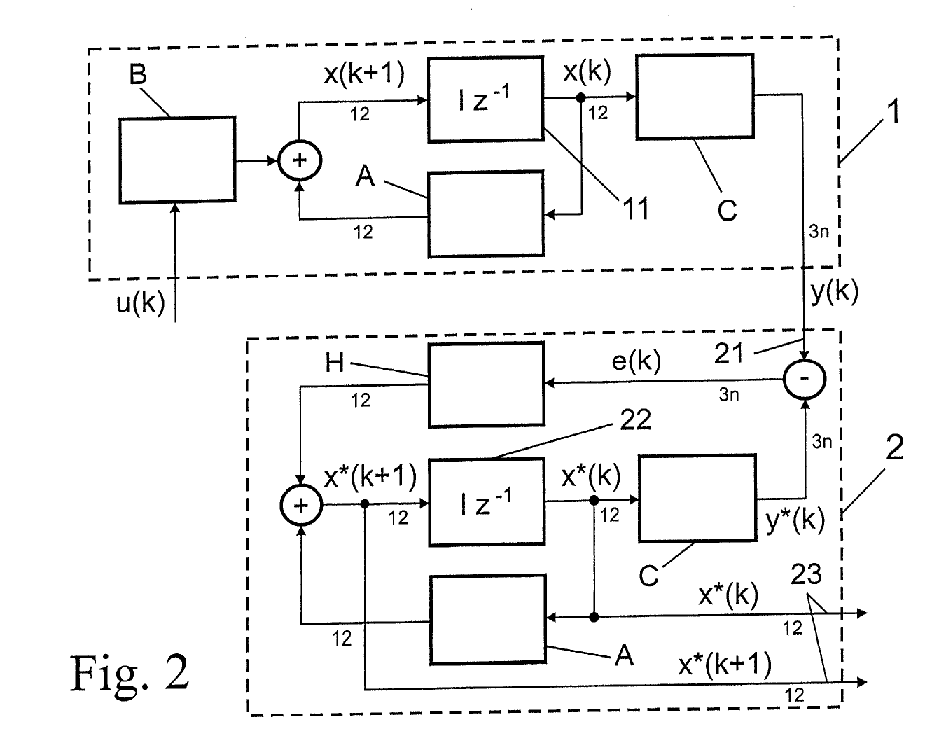

The method according to the invention for determining said state variables, as illustrated in FIG. 2, is based on a principle of control engineering (Luenberger observer [Föllinger, O.: Regelungstechnik [Control engineering], Hüthig Buch Verlag, Heidelberg, 1990, pages 501-517]).

The upper part of FIG. 2 can be interpreted in terms of control engineering as a controlled system 1 (spacecraft with laser radar set). Belonging to this system are an input vector u, an input matrix B, a system matrix A, a state vector x, an output matrix C and an output vector y.

The input vector u, in which the drive signals and possible noise signals are combined, determines the state vector x of the moving spacecraft via the input matrix B. It is to be seen that the new state at the instant (k+1) comprises the current state x(k), weighted with the system matrix A, and the current input vector x, which is multiplied by the input matrix B. A downstream transfer element 11 with the unit matrix I symbolizes by the operation I z⁻¹ that the subsequent state x(k+1) after a scanning clock is transferred into the current state vector x(k). Combined in the output vector y are the measurement results r₁, r₂, r₃ for the adopted three rectroreflectors R₁, R₂ and R₃, which can be measured on the basis of the current state variables x(k) of the moving spacecraft. It is expedient to convert the measurement results of range, azimuth and elevation into Cartesian coordinates.

In the lower part of FIG. 2, is a model of the moving body, a so-called state observer 2. The system parameters, that is to say the system matrix A and the output matrix C, of the controlled system 1 of the moving body and of the state observer 2 are assumed to be identical. The special adaptation of the state observer 2 to the measurement problem of the prescribed controlled system 1 consists in that an input vector u is not used in the state observer 2, since it is not available. Consequently, estimated values y*(k) of the output signal are generated in the state observer 2; they correspond in the ideal case to the measurement results r₁, r₂, r₃ of the laser radar. However, since the input vector u is not available in the state observer 2, the next state is calculated from a currently estimated state vector x*(k) and a correction e(k), which includes the deviation of the real measurement vector y(k) from the measurement vector y*(k) estimated in the state observer 2. Thus, the influence of the input vector u from the controlled system 1 is also contained in this correction e(k).

The estimated measurement vector y*(k) is generated from the estimated state vector x*(k) via an output matrix C which includes the effect of the real state vector x(k) on the measurement vector y(k) measured by the laser radar. The correction e(k) obtained by forming the difference between the real measurement vector y(k) and the estimated measurement vector y*(k) is thereafter applied to the current estimated state vector x*(k) via a return matrix H, which contains a rule as to the extent to which the correction e(k) acts on the estimated state vector x*(k), the next estimated state, a subsequent state vector x*(k+1) resulting therefrom. The subsequent transfer element 22 symbolizes, as already in the controlled system 1 with I z⁻¹, that after one clock the subsequent state vector x*(k+1) is transferred into the current estimated state vector x*(k).

If the state vector x(k) of the controlled system 1 (spacecraft) corresponds with the estimated state vector x*(k) of the state observer 2 (computing model of the spacecraft), that is to say x(k)=x*(k), the real measurement vector y(k) and the measurement vector y*(k) estimated by the state observer 2 also correspond. The state variables of the moving spacecraft can then be read off directly at the output of the state observer 2.

If this correspondence does not obtain, the state vector x*(k) of the state observer 2, is corrected with the aid of a correction vector e(k) by making use of the return matrix H already mentioned above, until the error, that is to say the deviation between x(k) and x*(k), vanishes. This is performed on the basis of further scannings of the retroreflectors R₁ to R₃, and so the actual changes in position and attitude of the moving body (controlled system 1) always also participate directly. In this way, the state variables of the approaching body can already be read off directly at the output of the state observer 2 after a few scanning and calculating cycles.

When the data from the state observer 2 are being used, there is also in each case the option of deciding whether to make use, as the best approximated state, from the states of two sequential clocks, of the estimated or calculated state vector x*(k) or of the latter's subsequent state vector x*(k+1).

Dispensing with the representation of the controlled system 1 from FIG. 2 produces a simplified block diagram illustrated in FIG. 3, which specifies the relationship between the real measurement vectors y(k) (input 21 of the state observer 2) and the estimated state vectors x*(k) and x*(k+1) (output 23 of the state observer 2).

The structure illustrated in accordance with FIG. 3 corresponds to that of a digital filter. The input variables of this filter are the measured values of the laser radar r₁, r₂, r₃, which are combined as a real measurement vector y(k), and the desired state vectors x*(k) and x*(k+1) represent the output variables of the state observer designed as a filter.

FIG. 3 shows how the (new) subsequent state vector x*(k+1) results from the current state vector x*(k), multiplied by an operator 24, which results from the matrices already introduced above and whose calculating rule can be specified with the matrix operations A−HC and from the simultaneously given measurement results y(k), which are weighted with the return matrix H.

Such a filter is to be connected downstream of the laser radar set, which supplies the measured values rᵢ, in order to be able to determine the desired state variables by evaluating the available sequential state vectors x*(k) and x*(k+1).

The matrices used and their meaning are summarized once again in the following table for the purpose of understanding the operator 24 and of facilitating the explanations, based thereon, of the preferred exemplary embodiments of the invention.

| Matrix | Symbol | Meaning | Comments |
|---|---|---|---|
| System | A(12 × | describes the influence of | for relatively large Euler |
| matrix | 12) | the current state x(k) on | angles (>10°), x(k + 1) = |
| | | the subsequent state | A x(k) is to be replaced |
| | | x(k + 1) in accordance with | by a function x(k + 1) = |
| | | equation (3) | f[x(k)] |
| Output | C(3n × | describes the effect of the | for relatively large Euler |
| matrix | 12) | state vector x on the | angles (>10°), y(k) = C |
| | | measurement vector y in | x(k) is to be replaced by |
| | | accordance with equation | the function y(k) = g |
| | | (2), n is the number of | [x(k)] |
| | | retroreflectors Rᵢ | |
| Return | H(12 × | describes how the error | determines the stability |
| matrix | 3n) | signal is used to correct the | and the convergence |
| | | state vector in the state | speed of the state |
| | | observer 2, n is the number | observer |
| | | of retroreflectors Rᵢ | |

The dynamic response of the state observer 2 in accordance with FIG. 2 or 3 can be expressed with the aid of the equation

x*(k+1)=Ax*(k)−HCx*(k)+Hy(k) (3)

Equation (3) can be applied directly in accordance with FIG. 3 when, for example, the positions and attitudes of the three retroreflectors R₁, R₂ and R₃ are measured simultaneously with three laser beams. In this case, the output vector has the form of y=(r₁′, r₂′, r₃′)′, the apostrophe respectively denoting the transposed vector. This is normally an excessively high technical outlay. For this reason, it is desired to execute the measurement of the three (or more) retroreflectors Rᵢ sequentially in time with the aid of a laser radar.

The mode of procedure according to FIG. 2 or 3 cannot be used directly for a volume- and weight-orientated achievement of the object according to the invention, since

the scanning of the retroreflectors Rᵢ (i=1, 2, . . . , n; n≧3) is performed sequentially in time, and so the time-discrete system has two scanning frequencies, a measurement clock frequency fₚ of the serial scanning of the retroreflectors Rᵢ and a cycle clock frequency of the calculation of the state vectors, which both are related via the number n of the retroreflectors Rᵢ used, fₚ=n f_{C};

the retroreflectors Rᵢ are located at different positions, and so the output matrices Cᵢ are different for the n retroreflectors Rᵢ;

a suitable return matrix Hᵢ must be selected for each of the retroreflectors Rᵢ, and

the Eigen values of the state observer 2 are to be set as a function of the operating mode of the laser radar.

In the phase of larger range, the state variables are to be measured with lower accuracy, the state observer 2 must be able to settle more quickly, that is to say the estimated measurement vectors y*(k) must be approximated more quickly to the real measurement vectors y(k). Right close to the docking operation, the approaching speed is low, and it is therefore sensible to inertly dimension the state observer 2 so as to obtain a higher accuracy through effective averaging.

For the purpose of applying linear relationships between the real state vector x(k) of the moving body (controlled system 1), on which the laser radar set is located, and the measurement vector y(k)=(r₁′, r₂′, r₃′)′, it is assumed that the Euler angles, which describe the relative attitude of the two approaching bodies with respect to one another, are small enough (<10°). Otherwise, the measurement vector y(k) would need to include nonlinear functions as a function of the state vector x(k), and this is possible without difficulty in principle and is to be taken into account for specific applications.

Starting from the above equation (3), the principle of the state observer 2 is modified in the following way in the case of three retroreflectors R₁, R₂, R₃ to be scanned sequentially in time:

x*(k+Δ)=(A_{S}−H₁C₁)x*(k)+H₁y₁(k),

x*(k+2Δ)=(A_{S}−H₂C₂)x*(k+Δ)+H₂y₂(k+Δ)

x*(k+1)=(A_{S}−H₃C₃)x*(k+2Δ)+H₃y₃(k+2Δ). (4)

In a first section of the cycle clock, Δ=1/3, a new estimated value is calculated on the basis of an initial value x*(0) of the state vector x*(k) to be estimated, by using the measurement result y₁(k)=r₁ at the retroreflector R₁. This resulting estimated state vector x*(k+Δ) is improved with the aid of the next measurement y₂(k+Δ)=r₂ at the retroreflector R₂, the result being x*(k+2Δ). Finally, in the third and last section of the cycle clock the measurement result y₃(k+2Δ)=r₃ of the retroreflector R₃ is used to determine a further estimated value x*(k+3Δ) as new state vector x*(k+1). The next cycle of the three cycle sections just described begins therewith.

It follows from the system of equations (4) that

each retroreflector R₁, R₂, R₃ has its own output matrix C₁, C₂, C₃;

the corresponding return matrix H₁, H₂, H₃ is to be determined for each output matrix C₁, C₂, C₃;

a system matrix Aₛ is required which belongs to the clock section Δ=1/3f_{C}, the factor 3 in the denominator resulting from the number n=3 of the retroreflectors Rᵢ;

the intrinsic behavior, and thus the convergence of the state observer 2 is determined by the matrices C₁, C₂, C₃, H₁, H₂, H₃ and Aₛ, and

the updated estimated value of the state vector x* is available at each measurement clock.

The equations specified above can be used to determine a filter structure derived from FIG. 3, and this is illustrated in FIG. 4. In this case

the matrix 25 signifies a resulting system matrix M of the state observer 2, whose Eigen values determine the stability and convergence of the simulated approach process of the moving body, where

M=[Aₛ(k)−H₃C₃][Aₛ(k)−H₂C₂][Aₛ(k)−H₁C₁] (5)

and

the weighting operators 251, 252 and 253 signify a special weighting for each of the temporally clocked measurement vectors y₁, y₂ and y₃ arriving at separate inputs 211, 212 and 213.

In this case, the weighting operators 251, 252, 253 include

weighting matrices Mᵢ, which take account of the different instants ( . . . , k, k+Δ, k+2A, k+3Δ=k+1, . . . ) and therefore the up-to-dateness of the measurement vectors yᵢ, where

M₁=[Aₛ(k)−H₃C₃][Aₛ(k)−H₂C₂],

M₂=[Aₛ(k)−H₃C₃]

M₃=I, (I=unit matrix), (6)

and

return matrices H₁, H₂, H₃, which specify which influence is exerted by the measurement vectors y₁, y₂, y₃ on the correction of the state vector x*.

The layout in accordance with FIG. 4 for implementing this filter structure operates with the cycle clock frequency f_{C}, which corresponds in the case of three retroreflectors to the threefold measurement clock frequency fₚ of the laser radar set (f_{C}=3fₚ). The filter structure therefore includes settable system parameters which specify

how it is possible to use the matrix 25 to stipulate the transient response, the dynamics, of the state observer 2,

how the temporal sequence of the measurement vectors yᵢ contributes to the state vector x* at the output 23 of the state observer 2.

FIG. 4 therefore specifies a solution in the case of which temporally sequentially occurring measured values (measurement vectors yᵢ) are simultaneously processed after a short buffering, and a subsequent state vector x*(k+1) is output in each case at the end of a cycle of n measurement clocks.

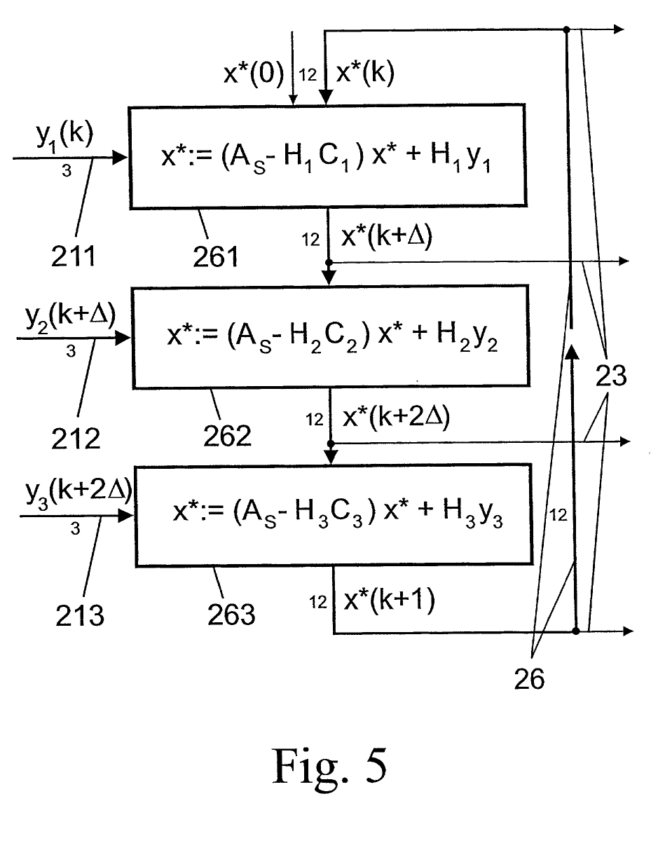

The state observer 2 according to the system of equations (4) is illustrated in the form of a program loop 26 in FIG. 5. By contrast with FIG. 4, this shows that exactly one updated state vector x* is available after each measurement clock. Use is made of three retroreflectors R₁, R₂, R₃ in this example as well. The conditions for a linear state observer 2 (small Euler angle) are to be fulfilled.

If the process begins with the starting value x*(0), the first updated state vector x*(k+Δ), k=0, is calculated as the result of the first measurement clock in accordance with the equation in the first block 261, using y₁(k), k=0. The instruction in the second block 262 is executed with this state vector x*(k+Δ) and the measurement y₂(k+Δ), k=0. The third block 263 is processed in a similar way, and the first cycle is thereby terminated. The result is the estimated value x*(k=1). This estimated value is used as starting value for the next cycle, in which it now holds that k=1. In this sequence, the further measurements [measurement vectors y₁(k)] are used to estimate the respective next subsequent state vector x*(k+1) of the moving spacecraft.

The reliable mode of operation of the method in accordance with FIG. 5 depends substantially on the dimensioning of the matrices used:

The system matrix A_{S} describes the relationship of the state variables between two successive instants when no further measurement vectors y₁ act on the inputs 211, 212, 213 (so-called autonomous system).

The output matrices C₁, C₂, C₃ specify the relationship between the state variables and the three components of the real state vector x(k) or of the calculated state vector x*(k) from the origin of coordinates of the laser radar set to the relevant retroreflector R₁, R₂ or R₃.

The matrices H₁, H₂, H₃ are suitably dimensioned weighting matrices. They determine how the deviation between the measured measurement vector y(k) and the measurement vector y*(k) estimated in the state observer 2 is used to correct the estimated state vector x*(k).

If the Euler angles become relatively large, the linear relationships are also to be replaced in FIG. 5 by functions of the form

x*:=f₁(x*, y₁), x*:=f₂(x*, y₂), x*: f₃(x*, y₃)

They represent combinations of the partial functions specified in the table.

After approximately three cycles, that is to say three passes of the closed-loop control circuit 26 with successive inclusion of the measurement vectors y₁, y₂, y₃ provided successively by the ordered scanning of the retroreflectors R₁, R₂ and R₃, the state variables of the moving body can be obtained with sufficient accuracy for many cases. A further advantage of this variant of the method according to the invention consists in that it is also possible to use the estimated state variables to calculate the approximate attitude of the next retroreflector Rᵢ, and this signifies an improvement in the measurement operation through suitable selection of the field of view of the laser radar.

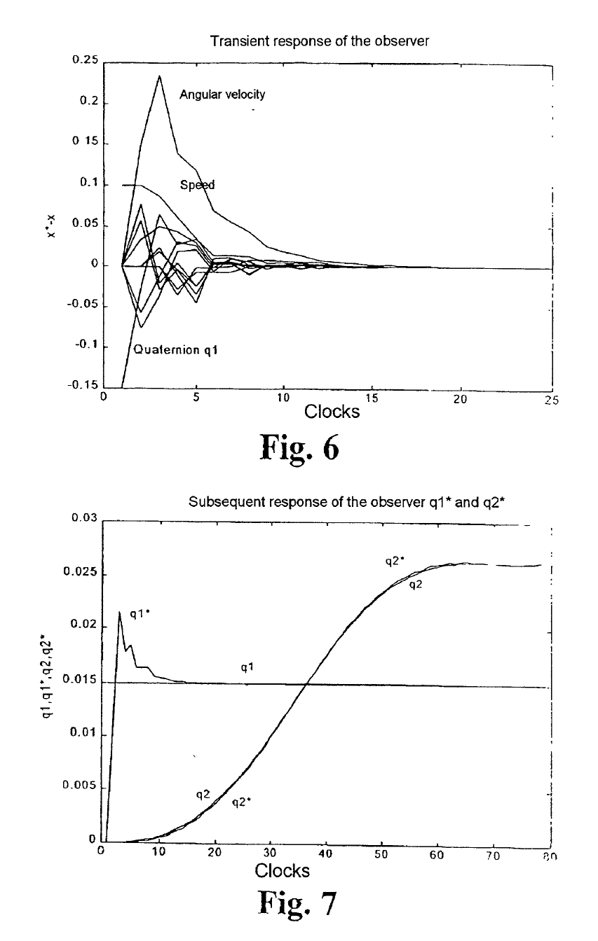

FIG. 6 shows the settling process of the state observer 2 for the last example of the successive processing of the measurement vectors yᵢ. The spacecraft and state observer 2 have different initial conditions at the starting instant of the measurement. After approximately three cycles of three clocks in each case, the error in the state vectors x*(k)−x(k) is virtually zero. This becomes particularly clear in this example with the quaternion q₁, the associated angular velocity and the translational speed in the x direction. The remaining curves represent the deviations of the other state variables.

FIG. 7 illustrates the way in which the state observer in accordance with FIG. 5 tracks the changing state variables of the moving spacecraft. If, for example, the quaternion q₁ (which corresponds to the roll angle) changes virtually with a jump, the state observer follows in a relatively short time by overshooting. The quaternion q₂ (which corresponds to the pitch angle) changes simultaneously, in an approximately sinusoidal fashion, and the state observer can track very accurately. The estimated value for the quaternion q₂* generated by the state observer is virtually equal to the real value q₂. The other state variables likewise exhibit a virtually identical response, as a result of which the efficiency of the last variant of the method according to the invention is impressively verified.

Similar results are also obtained, however, for the fundamental variant of the invention. This also applies to the design according to FIG. 4, in which—on account of the necessity for a respective complete series of scannings of the retroreflectors—the subsequent response of the state observer has only a coarser time grid in outputting the state variables.

While the foregoing description and drawings represent the present invention, it will be obvious to those skilled in the art that various changes may be made therein without departing from the true spirit and scope of the present invention.

List of reference symbols used

| | |
|---|---|
| 1 | Controlled system (spacecraft) |
| 11 | Transfer element |
| 2 | State observer |
| 21 | Input |
| 211, 212, 213 | Clocked inputs |
| 22 | Transfer element |
| 23 | Output |
| 24 | Operator (A-HC) |
| 25 | Matrix M |
| 251, 252, 253 | Weighting operators (MᵢHᵢ) |
| 26 | Closed-loop control circuit |
| 261, 262, 263 | Block |
| A | System matrix |
| B | Input matrix |
| C | Output matrix |
| H | Return matrix |
| Rᵢ | Retroreflectors |
| pᵢ | Position vector |
| q₁, q₂ . . . | Quaternions |
| r₁ | Measurement vector (relative to the retroreflector R₁) |
| t₁ | Target vector |
| (x_{C}, y_{C}, z_{C}) | Coordinate system (of the moving body) |
| (x_{T}, y_{T}, Z_{T}) | Coordinate system (of the target) |
| x | Real state vector |
| x*(k) | Estimated (calculated) state vector |
| x*(k + 1) | Subsequent state vector |
| y,/y* | Real/estimated measurement vector |

What is claimed is:

1. A method for determining the state variables of a moving rigid body, such as relative position and attitude as well as translational and rotational speeds, in particular for a movement of approach to another body employing measured data provided by an active sensor, the measured data being derived from at least three rectroreflectors whose configuration on the other body is known and is assigned in a defined fashion to a body-specific coordinate system of the other body, comprising the steps of:
determining the state variables of said moving body with the aid of a state observer which processes the measured data of scannings of individual rectroreflectors in space by an internal memory model to produce a desired output of the state variables of said moving body; in which case,
starting from set initial values and known system parameters implemented in operators, a current state vector of said moving body is calculated as an estimate;
using a correction determined by linkage with the measured data to adapt said estimate with each measuring cycle to the actual attitude characteristic and movement characteristic of the body, such that after a specific number of measuring and calculating cycles the estimated values calculated in the state observer track the current movement data of said moving body in space to a very good approximation; and
in using the calculated estimated values as state variables of said moving body.

2. The method as claimed in claim 1, including the steps of comparing measured data with the estimated values present in the state observer, and determining a difference (e(k)) between a measurement vector (y(k)) and the current estimate of a state vector (x*(k)), k being a counting index of the running measurement clock and calculation clock, and using said difference to correct the estimated values.

3. The method as claimed in claim 2, including the steps of:
generating an estimated measurement vector (y*(k)) for providing an estimated reference variable from a currently estimated state vector (x*(k)) by an output matrix (C) which contains the effect of the real state vector (x(k)) on the measurement vector (y(k));
calculating a subsequent state of the state vector (x*(k)) from the currently estimated state vector (x*(k)) via a system matrix (A) which takes account of influences of the system upon transition from a current state to a subsequent state; and
correcting this subsequent state by the difference (e(k)) by using a return matrix (H) which contains a rule for converting the difference (e(k)) into a correction of the current state; and
on the basis of said correction, the subsequent state yields a subsequent state vector (x*(k+1)) which is taken over into the current state vector (x*(k)) for the next clock.

4. The method as claimed in claim 3, wherein the state observer is designed as a filter, in which case
the output matrix (C) and the return matrix (H) are linked with the system matrix (A) to generate an operator for generating a subsequent state which describes the relationship between two sequential estimated state vectors (x*(k);
x*(k+1)) without knowledge of the estimated measurement vector y*(k) and independently of the current measurement vector (y(k));
the subsequent state of the current estimated state vector (x*(k)) is calculated therefrom by means of the operator;
the generated subsequent state of the state vector (x*(k)) is corrected with the aid of the measurement vector (y(k)) converted via the return matrix , and is transferred into the subsequent state vector (x*(k+1)); and
the subsequent state vector (x*(k+1)) is provided optionally parallel to the still present current state vector (x*(k)) as output (23) of the state observer.

5. The method as claimed in claim 1, wherein the measured data of a plurality of simultaneously scanned rectroreflectors (Rᵢ), which are combined in one measurement vector (y), are processed in the state observer simultaneously with the measurement clock frequency (fₚ) of the scanning, a cycle clock of the calculations in the state observer corresponding to the measurement clock of the scanning of the retroreflectors (Rᵢ).

6. The method as claimed in claim 1, wherein the measured data of a plurality of sequentially scanned retroreflectors (Rᵢ) are processed in the form of measurement vectors (yᵢ) in the state observer with a cycle clock frequency (f_{C}) whose period corresponds to the duration of a series of scannings of all retroreflectors (Rᵢ) with a measurement clock frequency (fₚ), it holding for n retroreflectors that fₚ=n f_{C}.

7. The method as claimed in claim 6, wherein the measurement vectors (yᵢ) of sequentially scanned retroreflectors (R₁) are buffered in the state observer, weighted as a function of their temporal sequence and simultaneously processed in a cycle clock after termination of a series of scannings of all retroreflectors (R₁).

8. The method as claimed in claim 7, wherein
the measurement vectors (yᵢ) arriving sequentially in time are buffered in a state observer designed as a filter, and
are weighted differently as a function of the measuring instant by means in each case of an associated return matrix (Hᵢ) and a weighting matrix (Mᵢ) which takes account of a forgetting rate dependent in terms of time on the age of the measurement vectors (yᵢ), and
the current state vector (x*(k)), which is multiplied by the matrix (25) which embodies the memory over n measurement clocks is corrected with the aid of the specifically weighted and subsequently combined measurement vectors (yᵢ).

9. The method as claimed in claim 1, wherein the measured data of sequentially scanned retroreflectors (Rᵢ) are processed in quasi-real time, with short-term buffering, in the form of measurement vectors (yᵢ) in the state observer with a measurement clock frequency (fₚ) which corresponds to the mean duration of the scannings of each of the retroreflectors (Rᵢ).

10. The method as claimed in claim 9, wherein each of the measurement vectors (yᵢ) which are picked up in a defined sequence of the scanned retroreflectors (Rᵢ), are processed without delay in the state observer, in which case, respectively,
the individual measurement vector (yᵢ(k)) is weighted with the aid of a return matrix (Hᵢ), which is appropriately matched to an output matrix (Cᵢ) specific to each retroreflector (Rᵢ), and
a subsequent state, which is instantly the initial state for processing the next measurement vector (yᵢ₊₁(k+iΔ) of the subsequently scanned retroreflector (Rᵢ₊₁), is calculated from the weighted measurement vector (yᵢ(k)); and the present current state vector (x*(k)), which is multiplied by a matrix (A_{S}−Hᵢ Cᵢ) representing the memory via a measurement clock.
